(19) United States
(12) Patent Application Publication
(10) Pub. No.: US 2013/0173952 A1
(43) Pub. Date: Jul. 4, 2013

(54) ELECTRONIC DEVICE AND METHOD FOR LOADING FIRMWARE

(71) Applicants: ZHENG-XIN GAO, Shenzhen City (CN); XIAN-KUI CHEN, Shenzhen City (CN)

(72) Inventors: ZHENG-XIN GAO, Shenzhen City (CN); XIAN-KUI CHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/565,808

(22) Filed: Aug. 3, 2012

(30) Foreign Application Priority Data
Dec. 30, 2011 (CN) 201110455915.8

(51) Int. Cl. G06F 11/14; G06F 9/00

(52) U.S. Cl. 714/3; 714/E11.112

(57) ABSTRACT

An electronic device includes an internal storage module, a baseboard management controller (BMC) and a port. The internal storage module stores a first firmware and a boot application. The port connects to an external storage for storing a second firmware which is a backup of the first firmware. After the electronic device is powered on, the BMC runs the boot application to load the first firmware from the internal storage module. If the first firmware fails to load, the BMC copies the second firmware from the external storage to the internal storage module to replace the first firmware.

### BACKGROUND

1. Technical Field

The present disclosure relates to an electronic device for loading firmware, and, particularly to an electronic device and a method for loading a firmware of a baseboard management controller.

2. Description of Related Art

Before starting an electronic device with a baseboard management controller (BMC), the BMC should be initialized first. The BMC is initialized by loading a firmware of the BMC which is pre-stored in a read-only memory (ROM) to the BMC by a universal boot loader (U-boot) application. However, if the firmware of the BMC is damaged, the electronic device cannot be started.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an electronic device for loading firmware in accordance with one embodiment.

FIG. 2 is a flowchart of a method for loading firmware of the BMC of the electronic device of FIG. 1.

### DETAILED DESCRIPTION

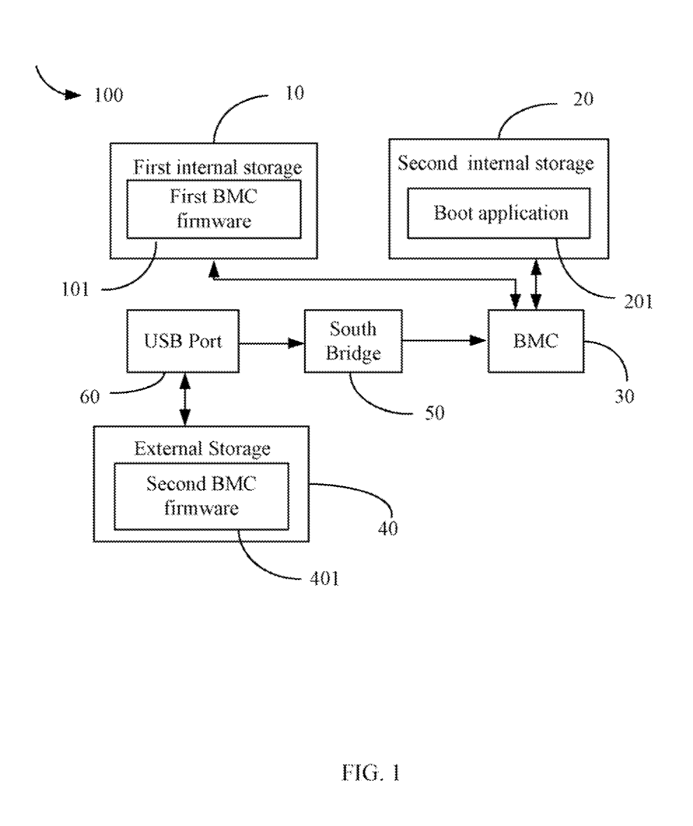

FIG. 1 is a block diagram of an electronic device 1 for loading firmware in accordance with one embodiment. The electronic device 100, such as a server, includes a first internal storage 10 and a second internal storage 20, both of which can be a flash read-only memory (flash ROM). The first internal storage 10 stores a first firmware 101. The second internal storage 20 stores a boot application 201 such as a universal boot loader (U-boot). The electronic device 100 further includes a baseboard management controller 30 (BMC). After the electronic device 100 is powered on, the BMC 30 runs the boot application to load the first firmware 101 to initialize the BMC 30. After the BMC 30 is initialized, the electronic device 100 can be started. In another embodiment, the boot application 201 can also be stored to the first internal storage 10.

The electronic device 100 further includes a port 50 for connecting an external storage 40. The external storage 40 stores a second firmware 401 which is a backup of the first firmware 101. In the embodiment, the external storage 40 is a universal serial bus (USB) disk and the port 50 is a USB port which is connected to the BMC 30 through a south-bridge 60.

When receiving power after the electronic device 100 is powered on, the BMC 30 runs the boot application 201 to load the first firmware 101 from the first internal storage 10. If the first firmware 101 is loaded successfully, the BMC 30 is initialized and the electronic device 100 can be started. If the first firmware 101 fails to load, the BMC 30 detects whether the external storage 40 is connected to the USB port 50. If the external storage 40 is connected to the USB port 50, the BMC 30 copies the second firmware 401 to the first internal storage 10 to replace the first firmware 101. After the first firmware 101 is replaced, the electronic device 100 is powered off and on again, and the BMC 30 runs the boot application 201 to obtain the replaced first firmware 101 to initialize the BMC 30.

In the embodiment, the first firmware 101 includes a checksum for indicating the integrity of the first firmware. If the checksum of the first firmware 101 is detected to be wrong, the BMC 30 determines a failure to load of the first firmware.

In the embodiment, if the first firmware 101 cannot be loaded from the first internal storage 10, the BMC 30 sets a loading failure identifier to the boot application 101. The BMC 30 detects whether the loading failure identifier exists in the boot application 201 so as to determine whether the first firmware 101 has successfully loaded. If the first firmware 101 is replaced, the BMC 30 deletes the loading failure identifier from the boot application 201.

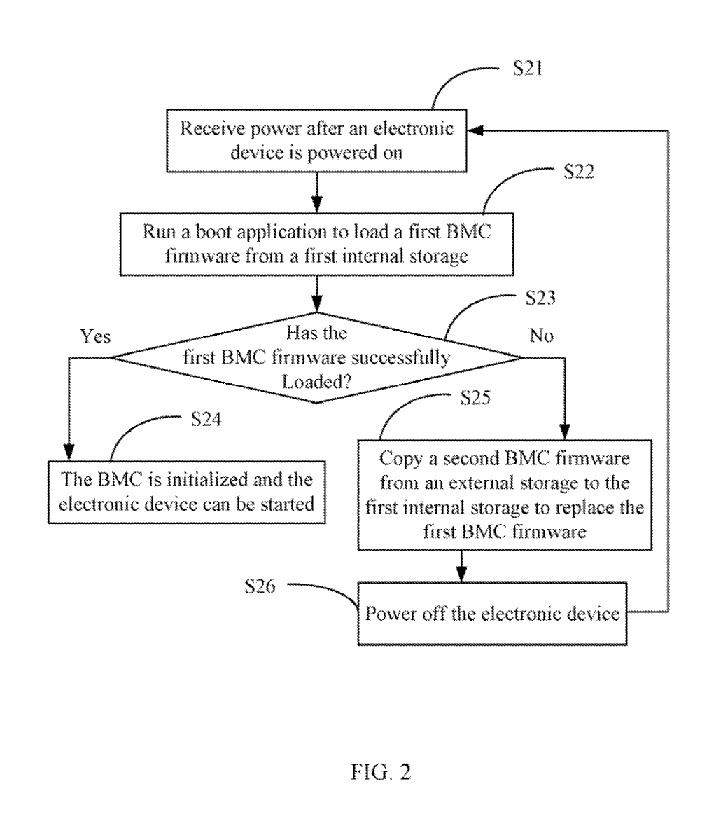

FIG. 2 is a flowchart of a method for loading firmware of the BMC of the electronic device of FIG. 1.

In step S21, the BMC 30 receives power when the electronic device 100 is powered on.

In step S22, the BMC 30 runs a boot application 201 to load the first firmware 101 from the first internal storage 10.

In step S23, the BMC 30 determines whether the first firmware 101 has successfully loaded.

In step S24, the BMC 30 is initialized and the electronic device 100 can be started if the first firmware 101 has successfully loaded.

In step S25, the BMC 30 copies the second firmware 201 from the external storage to the first internal storage 10 to replace the first firmware 101, if the first firmware 101 fails to load.

In step S26, after the first firmware 101 is replaced, the BMC 30 powers off the electronic device 100 and the procedure goes back to step S21 to power on the electronic device 100 again to reload the first firmware 101 from the first internal storage 10.

In another embodiment, if it is determined that the first firmware 101 has failed to load in step S23, the BMC 30 sets the loading failure identifier to the boot application 201 before implementing the step S25. After the electronic device 100 is powered on, in step S23, the BMC detects whether the loading failure identifier exists in the boot application 201 so as to determine whether the first firmware 101 has successfully loaded. If the first firmware 101 is replaced, the BMC 30 deletes the loading failure identifier from the boot application 201.

Although the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. An electronic device comprising:
an internal storage module for storing a first firmware and a boot application;
a baseboard management controller (BMC); and
a port for connecting an external storage which stores a second firmware which is a backup of the first firmware;
wherein when receiving power after the electronic device is powered on, the BMC runs the boot application to load the first firmware from the internal storage module, if the first firmware fails to load, the BMC copies the second firmware from the external storage to the internal storage module to replace the first firmware.

2. The electronic device as described in claim 1, wherein the first firmware comprises a checksum indicating the integrity of the first firmware, if the checksum of the first firmware is detected to be wrong, the BMC determines the first firmware fails to load.

3. The electronic device as described in claim 1, wherein if the first firmware fails to load from the first internal storage, the BMC sets a load failure identifier to the boot application, the BMC detects whether the load failure identifier exists in the boot application to determine whether the first firmware fails to load, if the first firmware is replaced, the BMC deletes the load failure identifier from the boot application.

4. The electronic device as described in claim 1, wherein the boot application is a universal boot loader (U-boot).

5. The electronic device as described in claim 1, wherein the port is a universal serial bus (USB) port and the external storage is a USB disk.

6. The electronic device as described in claim 1, wherein the internal storage module comprises a first internal storage for storing the first firmware and a second storage for storing the boot application.

7. The electronic device as described in claim 1, wherein the internal storage module comprises one internal storage for storing both the first firmware and the boot application.

8. The electronic device as described in claim 1, wherein the USB port is connected to the BMC through a south-bridge.

9. The electronic device as described in claim 1, wherein after the first firmware is replaced, the electronic device is powered off.

10. A method for loading firmware of a BMC of an electronic device, comprising:
storing a first firmware and a boot application in an internal storage module;
storing a second firmware which is a backup of the first firmware in an external storage which is connected to a port of the electronic device;
running the boot application to load the first firmware from the internal storage module; and
copying the second firmware from the external storage to the internal storage module to replace the first firmware if the first firmware is failure to be loaded.

11. The method as described in claim 10, wherein the first firmware comprises a checksum for indicating integrity of the first firmware, if the checksum of the first firmware is detected to be wrong, the BMC determines the first firmware fails to loaded.

12. The method as described in claim 10, wherein if the first firmware fails to load from the internal storage unit, the BMC sets a load failure identifier to the boot application, the BMC detects whether the load failure identifier exists in the boot application to determine whether the first firmware fails to load, if the first firmware is replaced, the BMC deletes the load failure identifier from the boot application.

13. The method as described in claim 10, wherein the boot application is a universal boot loader (U-boot).

14. The method as described in claim 10, wherein further comprising the step of powering off the electronic device after the first firmware is replaced.
